(19) United States
(12) Patent Application Publication
(10) Pub. No.: US 2025/0033944 A1
(43) Pub. Date: Jan. 30, 2025

(54) Layout Tool Systems and Components

(71) Applicant: Milwaukee Electric Tool Corporation, Brookfield, WI (US)

(72) Inventors: Samuel A. Gould, West Allis, WI (US); Danielle K. Quan, Somerville, MA (US); Todd P. Kusik, Wauwatosa, WI (US); John J. Rymsza, Wauwatosa, WI (US); John S. Scott, Brookfield, WI (US); Gareth J. Mueckl, Milwaukee, WI (US); Richard M. Schieber, Milwaukee, WI (US); Samuel B. Petre, Brookfield, WI (US)

(21) Appl. No.: 18/781,670

(22) Filed: Jul. 23, 2024

Related U.S. Application Data
(60) Provisional application No. 63/515,663, filed on Jul. 26, 2023.

(51) Int. Cl. B66F 11/04; B66F 13/00

(52) U.S. Cl. CPC B66F 11/044; B66F 11/042; B66F 13/00

(57) ABSTRACT

Various aspects of laser layout systems are provided, including a movable platform and a laser device coupled to the platform and configured to emit one or more lasers. The platform optionally vertically raises and lowers to facilitate the user working on elevated surfaces, such as ceilings. The laser device emits laser(s) at the floor and/or ceiling to facilitate the user marking and/or installing at installation points.

### CROSS-REFERENCE TO RELATED PATENT APPLICATION

The present application claims the benefit of and priority to U.S. Application No. 63/515,663 filed on Jul. 26, 2023, which is incorporated herein by reference in its entirety.

### BACKGROUND OF THE INVENTION

The present disclosure is directed generally to the field of tools. The present disclosure relates specifically to layout tool systems and components related thereto.

### SUMMARY OF THE INVENTION

Various embodiments of the invention relate to layout tool devices and systems designed to improve efficiency, accuracy, ease, etc. of performing layout tasks, such as performing layout tasks while utilizing a mobile work platform, such as a mobile work platform with a lift.

One embodiment of the invention relates to a laser layout system including a mobile work platform including a base moveable across a floor, legs coupled to the base, and a lift coupled to the legs, and the laser layout system further including a laser device coupled to the lift. The lift actuates between a retracted position closest to the base and an extended position furthest from the base. The laser device is configured to emit one or more lasers at installation points on a surface. The laser device emits the one or more lasers based on one or more of Building Information Modeling (BIM) data to determine a height of a ceiling, data from a sensor that indicates a location of the lift, and data from a sensor that indicates an orientation of the lift.

Another embodiment of the invention relates to a laser layout system including a mobile work platform including a base moveable across a floor, legs coupled to the base, and a lift coupled to the legs. The laser layout system also includes an arm pivotally coupled to the lift, and a laser device coupled to the arm, the laser device configured to emit one or more lasers at installation points on a surface. The lift actuates between a retracted position closest to the base and an extended position furthest from the base.

One exemplary method of using the invention relates to method of using a laser layout system including receiving an image from a camera of one or more objects, detecting a selection portion on an electronic device that corresponds to a location in the image, and adjusting a laser emitted by a laser device to aim at the location on the one or more objects in response to the detection of the selection portion. The selection portion is detected via detecting a user interfacing with a touch screen interface that is displaying the image.

Another embodiment of the invention relates to a laser layout system including a laser device configured to emit one or more lasers at installation points on a surface, such as a ceiling, and a mobile work platform. The mobile work platform includes a base moveable across a floor, legs coupled to the base, and a lift coupled to the arms. The laser device is coupled to the platform. The lift actuates between a retracted position closest to the base and an extended position furthest from the base.

In various embodiments, the laser device emits the one or more lasers based on one or more of Building Information Modeling (BIM) data to determine the height of the ceiling, data from a sensor that indicates the location of platform, and data from a sensor that indicates the orientation of the platform, such as the distance that the legs are supporting the platform above the base. In various embodiments, the laser layout system includes a detector that facilitates the laser device determining the position of the laser device relative to a second laser device, and the laser device emits the one or more laser based at least in part on the determined position. In various embodiments, the laser layout system includes a marking device that marks a surface at an installation point, and the laser device receives an image of the mark and analyzes the image to identify the installation point.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a laser layout system, according to an exemplary embodiment.

FIG. 2 is a perspective view of a schematic of another laser layout system, according to another exemplary embodiment.

FIG. 3 is a top view of a schematic of another laser layout system, according to another exemplary embodiment.

FIG. 4 is a top view of a schematic of another laser layout system, according to another exemplary embodiment.

FIG. 5 is a top view of a schematic of the laser layout system of FIG. 4, according to an exemplary embodiment.

FIG. 6 is a perspective view of a device used with another laser layout system, according to another exemplary embodiment.

FIG. 7 is schematic of another laser layout system, according to another exemplary embodiment.

FIG. 8 is a schematic of the laser layout system of FIG. 7, according to an exemplary embodiment.

FIG. 9 is a perspective view of a marking system and the mark created by the marking system, according to an exemplary embodiment.

FIG. 10 is a perspective view of the marking system of FIG. 9 and the mark created by the marking system, according to an exemplary embodiment.

FIG. 11 is a perspective view of the marking system of FIG. 9 and the mark created by the marking system, according to an exemplary embodiment.

FIG. 12 is a perspective view of the marking system of FIG. 9 and the mark created by the marking system, according to an exemplary embodiment.

FIG. 13 is a perspective view of the mark created by the marking system of FIG. 9, according to an exemplary embodiment.

FIG. 14 is a bottom view of the marking system of FIG. 9 and the mark created by the marking system, according to an exemplary embodiment.

FIG. 15 is a schematic of a mark to be used with a laser layout system described herein, according to an exemplary embodiment.

FIG. 16 is a schematic of a mark to be used with a laser layout system described herein, according to an exemplary embodiment.

FIG. 17 is a schematic top view of a portion of another laser layout system, according to another exemplary embodiment.

FIG. 18 is a schematic top view of a portion of the laser layout system of FIG. 17, according to an exemplary embodiment.

FIG. 19 is a schematic top view of a portion of the laser layout system of FIG. 17, according to an exemplary embodiment.

FIG. 20 is a perspective view of a portion of the laser layout system of FIG. 17, according to an exemplary embodiment.

FIG. 21 is a schematic top view of another laser layout system, according to another exemplary embodiment.

FIG. 22 is a schematic top view of another laser layout system, according to another exemplary embodiment.

FIG. 23 is a schematic top view of another laser layout system, according to another exemplary embodiment.

FIG. 24 is a schematic view of another laser layout system, according to another exemplary embodiment.

FIG. 25 is a perspective view of a mobile work platform of another laser layout system, according to another exemplary embodiment.

FIG. 26 is a schematic view of a turret, according to an exemplary embodiment.

FIG. 27 is a schematic view of another turret, according to an exemplary embodiment.

FIG. 28 is a schematic view of another turret, according to an exemplary embodiment.

FIG. 29 is a schematic view of another turret, according to an exemplary embodiment.

FIG. 30 is a schematic view of another turret, according to an exemplary embodiment.

FIG. 31 is a schematic view of another turret, according to an exemplary embodiment.

FIG. 32 is a schematic view of the turret of FIG. 31, according to an exemplary embodiment.

FIG. 33 is a schematic view of another turret, according to an exemplary embodiment.

FIG. 34 is a schematic view of the turret of FIG. 33, according to an exemplary embodiment.

FIG. 35 is a schematic view of another turret, according to an exemplary embodiment.

FIG. 36 is a schematic view of the turret of FIG. 35, according to an exemplary embodiment.

FIG. 37 is a schematic view of another turret, according to an exemplary embodiment.

FIG. 38 is a schematic view of the turret of FIG. 37, according to an exemplary embodiment.

FIG. 39 is a schematic view of the turret of FIG. 37, according to an exemplary embodiment.

### DETAILED DESCRIPTION

Referring generally to the figures, various embodiments of laser layout systems are shown. The laser layout system includes a movable platform and a laser device coupled to the platform and configured to emit one or more lasers. The laser device optionally emits a first laser at a floor, such as at a first installation point that is marked, and a second laser at a ceiling, such as at a second installation point that is not marked yet. In various embodiments, the platform includes a base that is movable across a floor and a lift extending above the base. The lift vertically extends above the base varying distances to facilitate the user accessing elevated work surfaces, such as the ceiling. Applicant has observed that centralizing control of both the movable platform and the laser device with a user or users in the lift facilitates performing work at various installation points, such as elevated installation points (e.g., on the ceiling).

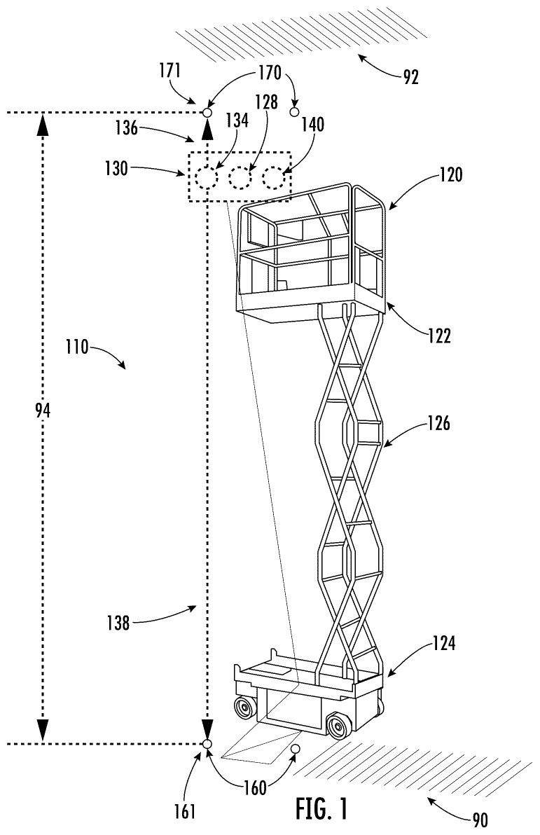

Referring to FIG. 1, laser layout system 110 includes a mobile work platform, shown as platform 120, and laser device 130. Platform 120 includes a base 124 movable across a surface, such as floor 90, legs 126 coupled to the base 124, and lift 122 that is coupled to base 124 via legs 126. Lift 122 actuates between a retracted position closest to the base 124 and an extended position furthest from the base 124 via legs 126 retracting and extending. As a result of the movability of lift 122 with respect to base 124, the distance between lift 122 and base 124 can be varied to facilitate the user accessing elevated installation points, such as on a ceiling. In various embodiments, lift 122 actuates vertically with respect to base 124 between the retracted position and the extended position.

Laser device 130 is coupled to lift 122 and includes a housing and a laser emitter 134 coupled to the housing. The laser emitter 134 is configured to emit one or more lasers 136 and 138 at a surface, such as a first laser 136 at installation points 160 on ceiling 92 and a second laser 138 at installation points 170 on floor 90.

In a first use case for laser layout system 110, the user moves the platform 120 until platform 120 is near an installation point 170 on the floor and/or an installation point 160 on the ceiling. Once within range, the laser device 130 projects laser 136 to intersect installation point 160 on the ceiling, and the laser device 130 projects laser 138 to intersect installation point 170 on the floor.

In various embodiments, laser device 130 projects lasers 136, 138 based on one or more of Building Information Modeling (BIM) data to determine the height 94 of the ceiling 92, data from a sensor 128 that indicates the location of lift 122, and data from a sensor 128 that indicates the orientation of lift 122 (e.g., the distance that legs 126 are supporting lift 122 above base 124). Based on that information, laser device 130 calculates the angle to project lasers 136, 138, and emits lasers 136, 138 to intersect installation point 160 and installation point 170, respectively.

In various embodiments, laser device 130 is configured to emit a first laser 136 of the one or more lasers 136, 138 upward from the laser device 130, and laser device 130 is configured to emit the first laser 136 at a first installation point 161 on the ceiling 92. In various embodiments, laser device 130 is configured to emit the first laser 136 at the first installation point 161 based at least in part on determining the height 94 of the ceiling 92 at least in part on the BIM data. In various embodiments, laser device 130 is configured to emit the first laser 136 at the first installation point 161 based at least in part on determining the orientation of the lift 122.

In various embodiments, laser device 130 is configured to emit a second laser 138 of the one or more lasers 136, 138 downward from the laser device 130, and laser device 130 is configured to emit the second laser 138 at a second installation point 171 on a floor 90.

In various use cases, installation points 170 are already marked on the floor. The markings on the floor are referred to by the user to facilitate identifying installation points 160 on the ceiling, such as by moving platform 120 until laser 138 intersects a first installation point 160, at which point laser 136 is pointing at the correlating installation point 160 on the ceiling. The user then optionally marks installation point 160 and/or performs the work on installation point 160 (e.g., installs a device, drills a hole).

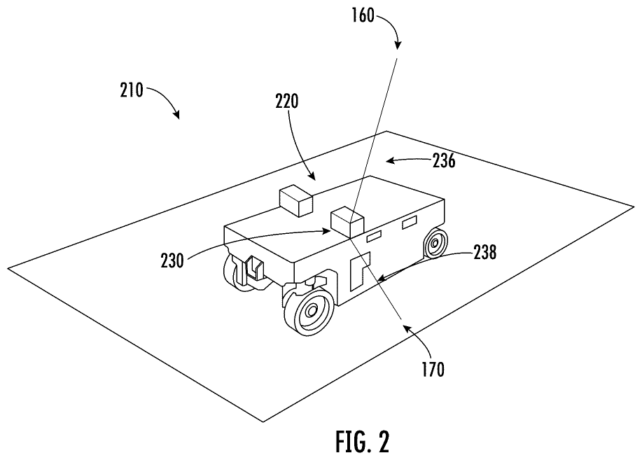

Referring to FIG. 2, various aspects of laser layout system 210 are shown. Laser layout system 210 is substantially the same as laser layout system 110 except for the differences discussed herein.

Laser device 230 is coupled to mobile work platform 220. Laser device 230 emits laser 236 upwards at installation point 160, and laser 238 downwards at installation point 170. In various embodiments, laser 236 and laser 238 are emitted at the same azimuth angle (e.g., angle along a horizontal plane with respect to a forward direction of the mobile work platform) but their angle with respect to vertical can be adjusted to move where lasers 236, 238 intersect the ceiling and floor, respectively.

In various embodiments, laser device 230 receives data that measures the distance to the floor and/or the ceiling, such as data received from laser distance measurer devices. In various embodiments, laser device 230 includes a first laser distance measurer device to measure the distance to the ceiling, and a second laser distance measurer device to measure the distance to the floor. The laser device 230 receives the distance measurement(s) from the laser distance measurer device(s) and adjusts the pitch angle of lasers 236, 238 so that lasers 236, 238 intersect installation points 160, 170, respectively, and are plumb with each other.

According to another embodiment of a laser layout system, a gantry (such as a 3D printer-style gantry) is installed to the base of the platform, and the gantry extends laterally, such as less than three feet. The laser device is coupled to the gantry. In use, the user moves the platform until the laser device coupled to the gantry is over the top of a point of interest (e.g., an installation point on the ground. The laser device emits a laser vertically upwards to intersect the ceiling at a point plumb to the point of interest on the ground. In various embodiments, this laser layout system includes a camera that emits images (e.g., wirelessly, via a wire) to a screen so the user can align the laser with a desired location, such as aligning the downward aiming laser with the point of interest on the ground.

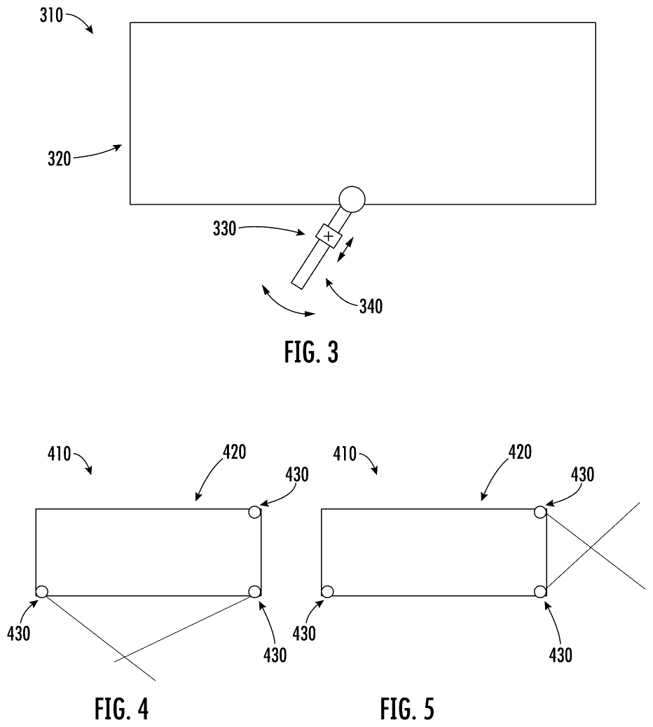

Referring to FIG. 3, various aspects of laser layout system 310 are shown. Laser layout system 310 is substantially the same as the laser layout system except for the differences discussed herein, including laser device 330 being substantially the same as laser device 130 except for the differences discussed herein.

In particular, laser layout system 310 includes an arm 340 coupled to platform 320, such as pivotally coupled to platform 320. Laser device 330 is coupled to arm 340, such as slidably coupled to arm 340. This rotational and sliding movement of arm 340 permits users to position the laser emitted by laser device 330 over a mark on the ground, such as with the aid of a camera showing where laser device 330 is emitting a laser.

In various embodiments, arm 340 of laser layout system 310 includes four bars and a slider.

In various embodiments, laser devices of the laser layout systems described herein are coupled to the shelf of platform, and/or to the front and back of platform. In various embodiments, laser devices of the laser layout systems described herein are coupled via magnets to the side of the base that platform extends from. In various embodiments, laser devices of the laser layout systems described herein are mounted on a ladder with one or more heads, and/or in the mobile work platform basket (e.g., on the lift).

Referring to FIGS. 4-5, various aspects of laser layout system 410 are shown. Laser layout system 410 is substantially the same as laser layout system 110 or laser system 210 except for the differences discussed herein.

Laser layout system 410 includes multiple laser devices 430 coupled to platform 420, such as to corners of platform 420. In various embodiments, users can couple laser devices 430 wherever the user wants on the platform. In various embodiments, laser devices 430 emit lasers up and/or down from the platform.

According to another embodiment of a laser layout system, the laser layout system includes a manually articulated arm with a self-leveling dot laser at the end of the arm. The user moves the arm to position the dot laser over a mark on the ground, and then the dot laser projects a second dot to the ceiling that corresponds to the mark on the ground (e.g., they are plumb with respect to each other).

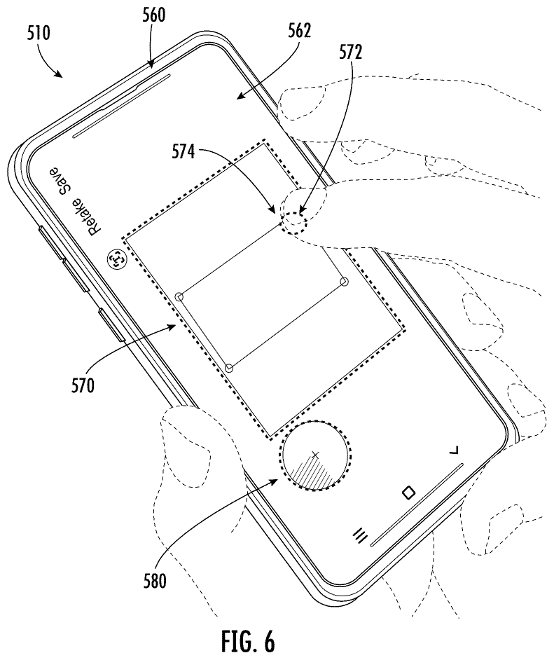

Referring to FIG. 6, various aspects of laser layout system 510 are shown. Laser layout system 510 is substantially the same as laser layout system 110, laser system 210, or laser system 410 except for the differences discussed herein.

Laser layout system 510 includes a camera, such as camera 140 in FIG. 1 included in laser layout system 110, and camera 140 transmits an image to a device, shown as cell phone 560. The image from the camera is displayed on touch screen interface 562 of cell phone 560, which in various embodiments is a display. For example, laser layout system 510 may send an image of the ceiling to cell phone 560.

While the base image 570 received from the camera is shown on touch screen interface 562, the user selects selected portion 572. Cell phone 560 then shows a detailed view (e.g., a zoomed-in view) of selected portion 572 at detailed image 580. The user can then move their finger to adjust selected portion 572 within the base image 570. Once the user is satisfied with location of the selected portion 572, the user removes their finger from the touch screen interface 562. Laser layout system 510 then moves the laser emitted to snap to the location identified by the user. In various embodiments, laser layout system 510 includes one or more lasers, one or more cameras, and uses a calibration routine between the laser(s), camera(s), and the ground.

According to a method of using laser layout system 510, an image 570 is received from a camera (e.g., camera 140) of one or more objects, a selection portion 572 on an electronic device (e.g., cell phone 560) is detected, and the selection portion 572 corresponds to a location 574 in the image 570, and the selection portion 572 is detected via detecting a user interfacing with a touch screen interface 562 that is displaying the image 570, and a laser (e.g., laser 136) emitted by a laser device (e.g., laser device 130) is adjusted to aim at the location 574 on the one or more objects in response to the detection of the selection portion 572.

In various embodiments, the electronic device includes cellular phone 560, such as a smart phone.

In various embodiments, the method includes displaying, in response to detecting the selected portion 572, a detailed view 580 of the selected portion 572. In various embodiments, the method includes displaying the detailed view 580 touch screen interface 562. In various embodiments, the method includes analyzing the image 570 to identify an installation point on a surface, such as laser layout system 510 analyzing the image 570 to identify marked installation points on a surface, such as a ceiling.

In various embodiments, laser layout system 510 facilitates the user selecting a mark, such as at a location on the ceiling. In use, the user places their finger on touch screen interface 562 in the vicinity of where the mark appears on the touch screen interface 562. Laser layout system 510 then searches the image for something that looks like a mark.

In various embodiments, laser layout system 510 facilitates the user selecting one or more marks, such as at a location on the ceiling. In use, an algorithm in laser layout system 510 analyzes the image to recognize marks made by the user. In various embodiments, this process is facilitated by the user using specific mark signatures (e.g., an “X”). This method may be used in conjunction with the user manually selecting locations in the image.

In various embodiments, laser layout system 510 automatically identifies marks without a video feed being provided to the user. In various embodiments, the laser device includes an input, such as a button, to toggle the laser layout system 510 to the next mark.

In various embodiments, a laser layout system is substantially similar to laser layout system 110, laser layout system 210, or laser layout system 510 except as otherwise described. The laser layout system includes a joystick that controls a position of lasers, such as the intersection of two or more lasers. For example, moving the joystick left/right/up/down would motorize both lasers counterclockwise/clockwise proportionally such that the intersection would travel left/right/up/down respectively from the user's perspective. In various use situations, the lasers would be calibrated to the camera and both the lasers and camera would be calibrated to the ground each time the device is setup.

In various embodiments, a laser layout system is substantially similar to laser layout system 110, laser layout system 210, or laser layout system 510 except as otherwise described. In various embodiments, this laser layout system includes two or more dials, such as dials that rotate. At low RPM (when the user is slowly rotating a dial), the laser would spin in a stepped fashion to help the user dial in to a target point. When the user's click rate of the dial reaches a certain threshold (e.g., when the user is quickly rotating the dial), the RPM of the laser would ramp up to help the user move the laser to a point further away (e.g., the angle of the laser would be adjusted more quickly).

In various embodiments, a laser layout system is substantially similar to laser layout system 110, laser layout system 210, or laser layout system 510 except as otherwise described. In various embodiments, this laser layout system includes one or more dials (e.g., two dials) that the user rotates to move the laser. In various embodiments, one or both of the dials include a toggle that switches the dial between a micro mode and a macro mode. For example, in the macro mode when the dial button is depressed a single rotation of the dial has a large effect on the location of the laser, and in the micro mode when the dial button is not depressed a single rotation of the dial has a small effect on the location of the laser.

In various embodiments, the laser layout system could use a 1:1 mode where the dial's current position would be considered the laser's current position and a rotation of the dial (e.g., a 50 degree rotation of the dial) rotates the laser a corresponding amount (e.g., 50 degrees). The user could optionally toggle between this mode and other modes, such as a micro or macro mode.

In various embodiments, the laser layout system(s) overlays lines on the display, such as X/Y lines. In various embodiments, this functionality is enabled by calibrating the camera with the environment (e.g., sensing the location of the camera with respect to the environment and analyzing the image captured by the camera based on the sensed location).

In various embodiments, there are two laser layout systems coupled to the same mobile work platform, and the user selects one of the laser layout systems on the mobile work platform for pairing (e.g., to pair the cell phone of the user).

In various embodiments, a laser layout system is substantially similar to laser layout system 110, laser layout system 210, or laser layout system 510 except as otherwise described. In various embodiments, this laser layout system overlays the laser(s) within the display being shown to the user. This may be particularly useful in well lit environments, such as outside on a sunny day.

In various embodiments, the laser layout system(s) described herein include buttons to centralize a location of the laser(s), such as a homing button to zero the lasers to a home location. In various embodiments, the laser layout system(s) described herein include a warning indicator to provide a warning (e.g., an audio alarm) if the user and/or platform is approaching an obstruction (e.g., a wall or a ceiling). In various embodiments, the laser layout system(s) described include extending components (e.g., an arm) that automatically retract when the platform is being moved, thereby helping protect the extending components from damage. In various embodiments, the laser layout system(s) described herein can be mounted at various locations on the platform, such as on the lip of the platform.

In various embodiments, the laser layout system(s) described herein do not include a camera. In various embodiments, the laser layout system(s) described herein include a camera providing an overhead view (e.g., for backing up the mobile work platform). In various embodiments, the laser layout system(s) described herein include a camera that is stationary and/or a camera that is moving on a turret. In various embodiments, the laser layout system(s) described herein include multiple cameras and the laser layout system(s) can optionally stich the images or videos together. In various embodiments, the laser layout system(s) described herein include one or more cameras that can be adjusted (e.g., panned, tilted, or zoomed). In various embodiments, the laser layout system(s) described herein use a color filter, such as in conjunction with a laser of the same color and/or a marker of the same color (e.g., green). In various embodiments, the camera is mounted as high as possible. In various embodiments, the laser layout system(s) described herein are used in conjunction with a special coating, such as a reflective paint and/or a UV light and glow-in-the-dark ink marks (e.g., phosphorescent material infused in paint). In various embodiments, the laser layout system removes marks on the ground entirely, such after the corresponding installation point on the ceiling has been marked then the laser layout system stops marking the laser on the installation point and/or the laser layout system stops displaying the mark on the display, such as a tablet.

In various embodiments, a laser layout system is substantially similar to laser layout system 110, laser layout system 210, or laser layout system 510 except as otherwise described. In various embodiments, one or more laser layout systems described herein use a pre-defined mark to assist in mark identification for installation points, such as pre-defined marks placed by a previous layout crew. The predefined shape could be easier to recognize on a camera and person due to its repeatable characteristics. The predefined shape could be made in the form of a sticker or many other marking methods.

In various embodiments, the laser device(s) emit a laser at the ground in a box-like shape to indicate the field of view for a corresponding camera, such as a camera being used in conjunction with the laser device(s).

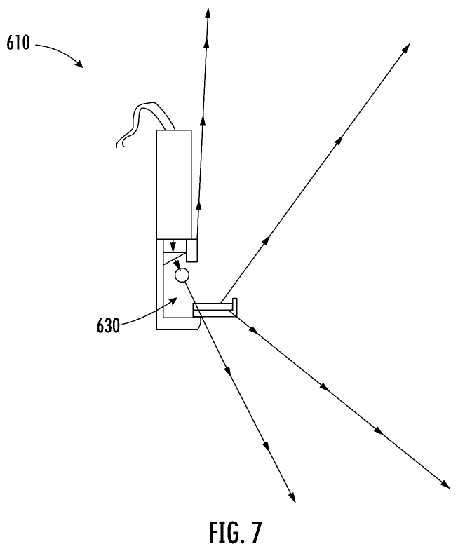

Referring to FIG. 7, various aspects of laser layout system 610 are shown. Laser layout system 610 is substantially the same as laser layout system 110, laser system 210, laser system 410, or laser system 510 except for the differences discussed herein.

In a first embodiment of laser layout system 610, laser device 630 includes two line lasers, such as rod lasers. One laser is aimed upward and the other laser is aimed downward and the lasers are aligned vertically and coplanar to each other.

In a second embodiment of laser layout system 610, laser device 630 includes a reflective object, such as a half silvered mirror. In a first example that involves pre-splitting, the arrangement is dot diode to rod lens to half silvered mirror. This arrangement shoots half the energy up and half the energy down in the shape of a line and puts little to no energy laterally. In a second example that involves post-splitting, the arrangement is dot diode to half-silvered mirror to rod lens. In a third example, adding a wedge lens permits the diode to be oriented vertically allowing for a more compact design (e.g., because a smaller diameter turret means greater protection of the mechanism on the side of platform and a greater field of view).

Referring to FIG. 8, in a third embodiment of laser layout system 610, the laser device 630 includes a vertical diode with a prism splitter that splits the laser. Similar to the second example of the second embodiment of laser layout system 610, this configuration uses one diode placed vertically, the laser bounces into a mirror or prism and into a splitter (e.g., a triangle splitter) that diverts the dot into two rod lenses (top and bottom create two vertical lines).

In various embodiments, the laser layout system uses a 360 degree cone-shaped mirror to facilitate reflecting the laser to the intended installation point(s), such as one side of the mirror reflecting the laser towards the floor and one side of the mirror reflecting the laser towards the ceiling.

In various embodiments, a laser layout system is substantially similar to laser layout system 110, laser layout system 210, or laser layout system 510 except as otherwise described. In various embodiments, this laser layout system includes a pendulum that levels the laser emitter on a single axis, thereby saving in size and cost compared to multi-axis leveling laser devices. If the devices are placed at a dramatically tilted angle that cannot be leveled (such as via being detected by an accelerometer), the device is configured to alert the user using a variety of currently-existing methods.

In various embodiments, the laser flashes to indicate that the laser device could not be leveled. In various embodiments, the laser device predicts the laser device will not be able to be leveled and start flashing the laser (e.g., if the platform that the laser device is coupled to is not level).

In various embodiments, the laser layout system(s) described herein use computer vision to find the mark(s). In various embodiments, the laser layout system(s) described herein use machine learning to identify and/or find the mark(s). In various embodiments, the laser layout system(s) described herein distinguish between marks intended for the laser layout system and marks intended for other entities.

In various embodiments, a laser layout system is substantially similar to laser layout system 110, laser layout system 210, or laser layout system 510 except as otherwise described. In various embodiments, this laser layout system helps protect the user from reaching out too far from the platform, thereby risking an accident. In one example, a line is overlayed on the controller video feed screen at a predetermined distance (e.g., three feet), and if the mark is past three feet, the user would see that their point is past the line and in the no-go region. In another example, the lasers flash if the lasers are aimed more than a predetermined distance (e.g., three feet) from the platform and/or bucket.

In various embodiments, a laser layout system is substantially similar to laser layout system 110, laser layout system 210, or laser layout system 510 except as otherwise described. In various embodiments, this laser layout system is configurable to flash the laser on and off slowly, such as while moving (e.g., slowly enough for a person to detect that the light is turning on and off, such as one second on and one second off). This permits the user to see both the laser and the underlying mark that the laser may be projected on. Turning the laser on and off slowly could also permit the laser device to confirm whether the laser has been correctly adjusted to hit the target mark. In various embodiments, the user can manually turn on/off the lasers.

In various embodiments, a laser layout system is substantially similar to laser layout system 110, laser layout system 210, or laser layout system 510 except as otherwise described. In various embodiments, this laser layout system calibrates various components, such as the laser device(s) and/or the camera(s). One method that can be used to calibrate the laser to the camera is to zero the lasers on a designated object, such as an end stop or a sensor that is a fixed (e.g., known) distance away from the camera(s).

Another method that can be used to calibrate the camera to the environment includes shining the lasers at various locations in the camera's field of view. By recording the expected and actual locations, the laser layout system may determine the height from the ground and the tilt of the lasers with respect to the ground. Another method that can be used to calibrate the camera to the environment includes measuring with a tape measure to one or more mark(s) on the ground, then aim the laser to these mark(s). Another method that can be used to calibrate the camera to the environment includes placing a card on the ground and have the camera calibrate itself to the orientation of the card, thereby deriving one or more of orientation, height, and laser position.

In various embodiments, marking systems are provided herein that produce unique marks, such as proprietary marks with unique shapes.

In various embodiments, the upward-aimed laser is blocked by an opaque or shaded material until the laser layout system is correctly positioned, at which point the material is moved the upward-aimed laser no longer blocks the laser.

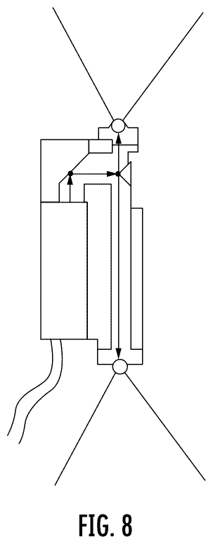

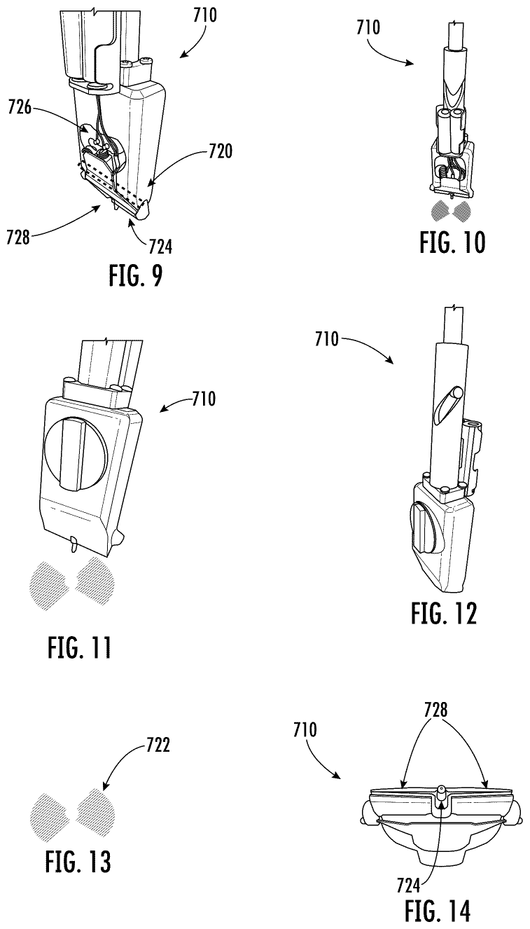

Referring to FIGS. 9-14, various aspects of marking system 710 are shown. Marking system 710 provides marks to be used by other laser layout systems described herein. In various embodiment, marking system 710 includes chalk box 720, pushpin 724, slit 728, motor 726, and chalk 722 within chalk box 720. In use, motor 726 opens and closes a slit 728 connected to chalk box 720, thereby permitting chalk 722 to exit chalk box 720. In various embodiments, slit 728 is spring-biased to be shut. In various embodiments, marking system 710 is mounted on a staff (e.g., a total station staff with a prism), on a rod to mark points while standing, or marking system 710 can be used in hand while bending over and pressing marking system 710 against the object being marked (e.g., the floor).

Chalk box 720 is filled with chalk 722 and an opening is sealed by slit 728. Motor 726 rests on slit 728 and a vibrator weight is positioned on the motor shaft. Pushpin 724 is aligned to the mark the user wants to make, and the user presses the pushpin 724 when ready to mark. The pushpin 724 closes a contact for the motor 726, which opens slit 728 allowing the chalk 722 to fall out. As the user pushes the pushpin 724 in further and further, there is a helical slot that causes the chalk box 720 to rotate 90 degrees. This 90-degree rotation ends when the pushpin 724 bottoms out. The resulting mark (see FIG. 13) is easily recognizable by computer vision and humans alike, removes the need to bend over, and uses chalk that can be found at a hardware store.

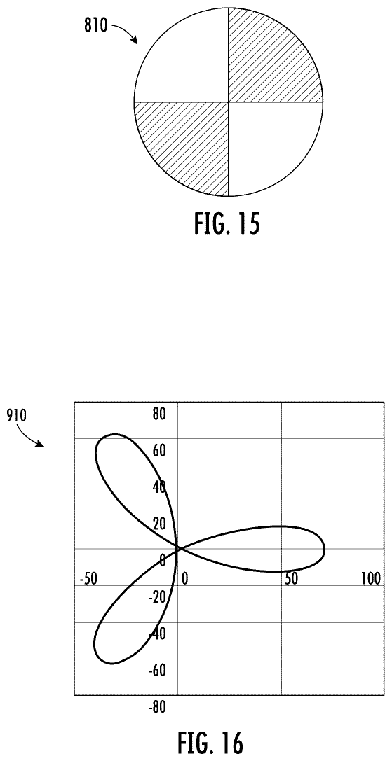

Referring to FIG. 15, various aspects of mark 810, such as an inkzall, are shown. In various embodiments, mark 810 is formed by forming a large tip, such as a felt tip, on a marker, such as a permanent marker, to mark locations identified by a user. The user could attach the marker to a pole or staff (e.g., a TRS staff), or use the marker by hand. The user would tap the marker on the ground at the desired location(s). The unique shape and configuration of the mark would facilitate the laser layout systems recognizing the marks with reduced user assistance. In various embodiments, the mark 810 is made by a TRS staff that includes a large threaded insert near the bottom of the body (e.g., a cylindrical pole). The threaded insert is configured to receive (e.g., via the threading) a tip that helps position the TRS staff at certain location(s), and/or to a marking device, such as a device that forms mark 810.

In various embodiments, a marking system is substantially similar to marking system 710. In various embodiments, this marking system utilizes spray paint or aerosolized chalk paint and a mask attached to a stick (or just a handheld unit that could optionally be attached to a total station staff to prevent bending over). The paint/chalk coats the ground in all the areas besides the intended spot creating a silhouette shape, such as in the shape of a Pac-man. The crease of mouth of the Pac-man would be the center of the mark. Depending on the situation and/or environment, certain colors can be selected to give high visibility, high mark permanence, and high accuracy.

In some scenarios (with paint especially), the mask will start pooling with paint so when the Pac-Man's mouth crease touches the next point, the pooled paint ruins the masked effect. This can be alleviated by putting more of the contact surface on the ground rather than just the point, or by putting a hydrophobic spray on the mask.

In various embodiments, the masked marks are placed next to user-placed unmasked marks that are placed with highly visible spray paint (e.g., a bright fluorescent color, a glow in the dark color and a UV light, such as on the mobile work platform). In various use cases, the user will clear coat the series of marks.

In various embodiments, a marking system is substantially similar to marking system 710. In various embodiments, a marking element (e.g., an inkzall, a marker, a pencil) is coupled to a motorized component or manually actuated wheel or cam that moves the marker in a pre-determined path to generate a reliable, visible, accurate, and digitally recognizable mark, such as mark 910 shown in FIG. 16. In various embodiments, the marks are layered (e.g., a clear coat above an inkzall above an orange dot).

In various embodiments, the laser layout system receives the location of multiple points, and an input, such as knobs, allows a user to adjust which points being identified by laser(s). In various embodiments, the points identified by laser(s) are determined at least in part based on the location of the mobile work platform (e.g., only the points closest to the mobile work platform and/or the points the mobile work platform is facing). In various embodiments, multiple tools (e.g., multiple laser layout systems) are used simultaneously and each tool uses a different color (e.g., blue, green, yellow).

In various embodiments, multiple laser layout systems are used together with a single station. In various embodiments, an LED tape is used (e.g., a tape with LED lights), and the lights are turned off/on based on the location of the installation points for the particular run of points being installed. In various embodiments, an installation tool is coupled to the mobile work platform that identified the installation point and automatically installs at the point (e.g., drills a hole).

In various embodiments, the laser layout system includes a gamification element where users are scored for how quickly they perform certain tasks. Thus, workers can be incentivized to work quicker by providing that worker a high score recently produced by one of their co-workers.

In various embodiments, a laser layout system is substantially similar to laser layout system 110, laser layout system 210, or laser layout system 510 except as otherwise described. In various embodiments, this laser layout system tracks the position and orientation of the platform and the laser layout system includes Building Information Modeling (BIM) data. Based on this information, the laser layout system can determine where the platform is located and which side of the platform the laser layout system is mounted (e.g., front, back, one of the sides). If the laser layout system determines that the platform is positioned at a spot that the laser cannot shoot without being blocked (e.g., the point is under the platform), the laser layout system would recognize that fact and alert the user to move the platform or preemptively alert the user to not drive to that location in the first place.

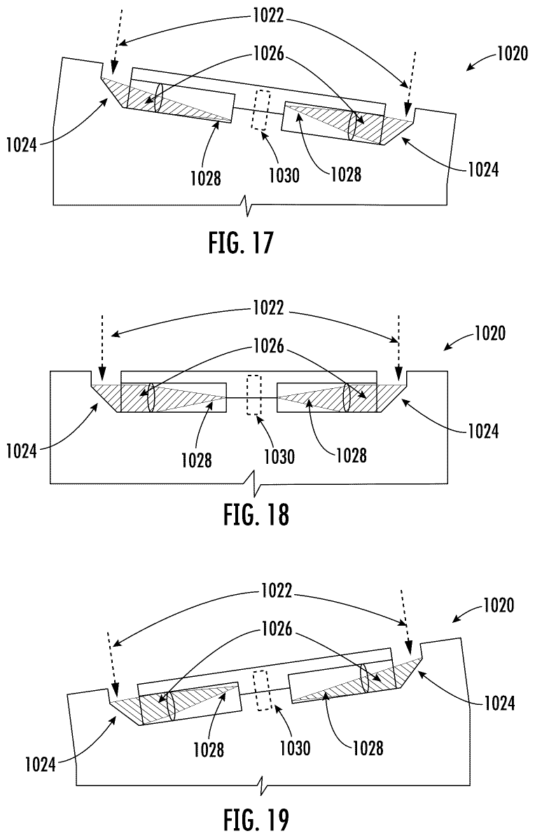

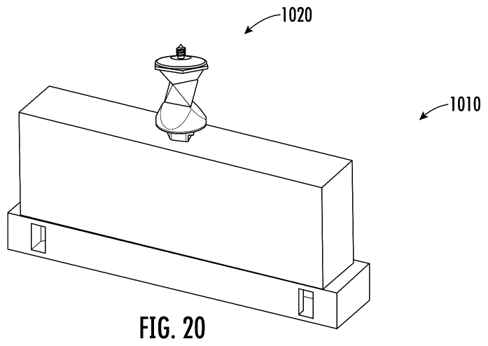

Referring to FIGS. 17-20, various aspects of laser layout system 1010 are shown. Laser layout system 1010 is substantially the same as laser layout system 110, laser layout system 210, laser layout system 310, laser layout system 410, laser layout system 510, or laser layout system 610 except for the differences discussed herein.

In particular, laser layout system 1010 utilizes a detector 1020 that facilitates laser layout system 1010 determining the position of laser layout system 1010 in a building environment. In particular, detector 1020 facilitates laser layout system 1010 identifying the orientation of laser layout system 1010 with respect to a device emitting a laser, such as a station on a building environment configured to help laser layout systems identify their location and orientation.

Referring to FIGS. 17-19, various aspects of incoming light 1022 entering detector 1020 at different angles are described. In use, incoming light 1022 enters detector 1020 and is reflected by reflector 1024 towards lens 1026 and sensor 1030. Lens 1026 focuses incoming light 1022 into focused light 1028, which intersects sensor 1030.

Based on where focused light 1028 intersects sensor 1030, detector 1020 can calculate the orientation (e.g., the azimuth angle of the laser layout system 1010 with respect to a device emitting the laser). For example, if the focused light 1028 intersects the center of sensor 1030 (FIG. 18), then detector 1020 can calculate that detector 1020 is perpendicular to the station emitting the laser (e.g., the detector 1020 is directly facing the station).

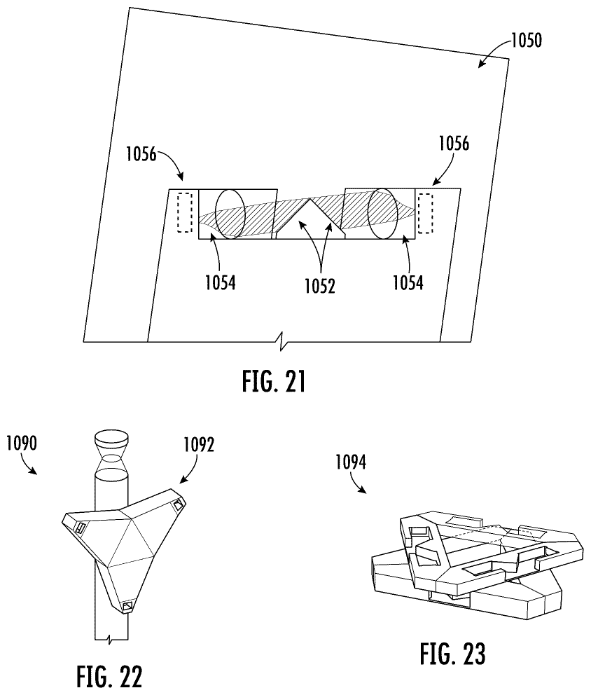

Referring to FIG. 21, various aspects of detector 1070 are shown. Detector 1070 is substantially similar to detector 1020 except for the differences discussed herein. In particular, reflectors 1074 and sensors 1080 are flipped so that incoming light is reflected away from each other into lenses 1076 and towards sensors 1080.

Referring to FIG. 22, a detector 1092 is shown attached to a moveable object, shown as staff 1090. In use, staff 1090 can be moved around to various locations and the location of staff 1090 can be calculated by light received by detector 1092. Detector 1092 is substantially similar to detector 1050 except for the differences described herein. In particular, detector 1092 calculates the angle of detector 1092 with respect to a station emitting light as well as the roll of staff 1090.

Referring to FIG. 23, a detector 1094 is substantially similar to detector 1092 except for the differences described herein. In particular, detector 1094 includes multiple detectors 1092 that are copied radially to enable detector 1094 to be detect light emitted at detector 1094 over the full 360 degree spectrum with respect to detector 1094.

In various embodiments, a magnetometer is used to facilitate determining the position of the platform.

In various embodiments, a laser layout system is substantially similar to laser layout system 110, laser layout system 210, laser layout system 510, or laser layout system 1010 except as otherwise described. In various embodiments, this laser layout system records a series of positions of the platform. If the laser layout system assumes and/or is notified that the laser layout system is coupled to the platform in a specific orientation (e.g., perpendicular to the heading of the platform, such as if the laser layout system is mounted to the front of the platform), then the orientation of the laser layout system can be calculated based on the series of positions.

In various embodiments, a laser layout system is substantially similar to laser layout system 110, laser layout system 210, laser layout system 510, or laser layout system 1010 except as otherwise described. In various embodiments, this laser layout system includes a plurality of visible objects (e.g., reflectors, IR LEDs, beacons) placed on the platform and/or the laser layout system, such as on the corners of the platform and/or base. As the platform and the laser layout system move around an area, an electronic object (e.g., a total station monitoring the environment) can monitor the visible objects and analyze their positions to determine the physical location and/or orientation of the platform and laser layout system. In various embodiments, the mobile work platform includes an angle sensor coupled to the base, and the angle sensor determines the angle of the base with respect to a total station.

In various embodiments, a laser layout system is substantially similar to laser layout system 110, laser layout system 210, laser layout system 510, or laser layout system 1010 except as otherwise described. In various embodiments, this laser layout system uses the azimuth-articulated axis of the laser device to detect a position and orientation with respect to a total station on site (e.g., via one of the detection methods identified above, such as shown in FIGS. 17-19 and/or FIGS. 22-23). Based on that information, a laser of the laser layout system is aimed back to the total station, such as at a laser detector placed on top of the total station. The laser layout system could determine its orientation with respect to the total station provided that the laser layout system was coupled to an encoder paired to the laser layout system axis and zeroed with respect to the housing.

In alternative embodiments, the laser layout system determines its position and/or orientation via a variety of methods. According to a first method, the laser layout system uses a lighthouse including three beacons, such as by calculating the position of the laser layout system with respect to the three beacons. In various embodiments, the laser layout system includes a first device that emits a first light spinning around the device, such as the first light being a vertical (or nearly vertical light). In various embodiments, the yaw angle the first light is being emitted from the first device can be calculated by one or more objects in the laser layout system, such as the first device (e.g., based on data received from an encoder and/or a tachometer that measures the rotation of the spinning first light). In various embodiments, the first device sends out a second light, such as a flash of light emitted over the 360 degree range with respect to and away from the first device. A moveable device, such as a TRS staff, includes a detector that detects the first light and the second light. Based on the relative timing of when the moveable device detects the first light and the second light, the moveable device can calculate its orientation relative to the first device. For example, if the spinning first light starts in the forward position and rotates once per second and the moveable device detects both the first light and the second light at the same time, then the moveable device would be able to determine the moveable device is in front of the first device. As another example, if the moveable device detects the second light at 0 seconds and the first light at 0.25 seconds (i.e., after one-quarter of a rotation), then the moveable device would be able to determine the moveable device is 90 degrees to the right of the first device.

According to a second method, the laser layout system uses laser distance measurer and two beacons. According to a third method, a total station emits light, such as from an LED, and the laser layout system utilizes a light detector, such as a camera, to detect the position of the LED.

In various embodiments, a laser layout system is substantially similar to laser layout system 110, laser layout system 210, laser layout system 510, or laser layout system 1010 except as otherwise described. In various embodiments, this laser layout system uses a pan-tilt turret that emits light (e.g., a laser light) onto the ground viewable by the user. The light/laser is emitted to intersect the ground in the proximity of the location of an installation point. As the user gets closer to the installation point, the light optionally also gets closer to the installation point. Once the user within a predetermined distance of the point, the position would be of a high-enough accuracy that it would be considered acceptable to be used for installation and/or marking.

In various embodiments, a laser layout system is substantially similar to laser layout system 110, laser layout system 210, laser layout system 510, or laser layout system 1010 except as otherwise described. In various embodiments, this laser layout system uses LED arrows that light up on a light array. In a first embodiment the LED arrows are located on a surface of the laser layout system, such as on a top face. In a second embodiment, the LED arrows are projected onto the ground for easier viewing for the user. Left/Right/Up/Down arrows would communicate to the users a rough direction to steer their platform to get to the next point.

In various embodiments, the railing of the platform can be adjusted. In various embodiments, a tablet interfacing with one of the laser layout systems described herein folds within the railing of the platform when the tablet is not in use, such as folding vertically within the railing of the platform. In various embodiments, the laser layout systems described herein are connected to the controls for the mobile work platform and/or the lift. In various embodiments, the laser layout systems described herein include a safety tether, such as for a person, and a handheld device, such as a cell phone or tablet. In various embodiments, the laser layout systems described herein include touch screen device, a camera integrated to help zoom in at the correct height, and/or an integrated feed to a total station so that the position to the next point is automatically communicated to the laser device.

In various embodiments, using one or more of the laser layout systems described herein includes one or more of measuring and marking point(s) on the ground, mounting the laser on the mobile work platform, mounting a controller (e.g., a tablet) on the platform, and adjusting cameras to the desired angle. Using the systems further optionally includes the user getting in the platform and raising the platform to the desired height, the user driving the mobile work platform close to a mark on the ground, the user optionally manually adjusting aim for one or more of the lasers, the user using the camera feed to check that the lasers cross over point (e.g., that the lasers intersect the correct point on the ground), marking a point on the ceiling, and moving to the next point to repeat one or more of these steps.

In various embodiments, using the laser layout systems described herein includes a camera taking video of the ground area, transferring video from a camera to a controller (e.g., via a signal, such as a wireless signal), and the controller displaying the feed to the user. Using the systems further optionally includes the user seeing the camera feed and adjusting the lasers, moving the mobile work platform, a micro controller sending a radio signal including a potentiometer signal, a receiver forwarding the signal to an MCU, and the MCU turning the signal into a command to adjust a motor that spins a laser.

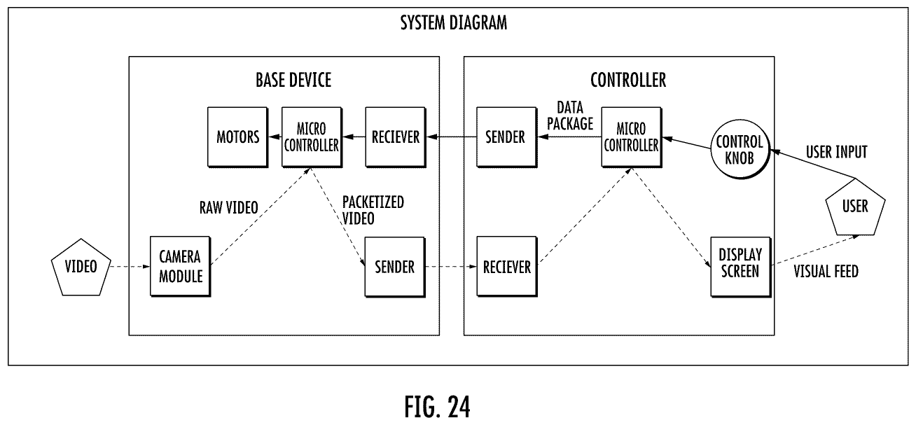

Referring to FIG. 24, various aspects of an exemplary laser layout system are provided. In particular, various aspects of the communication and control channels between components of the laser layout system are shown.

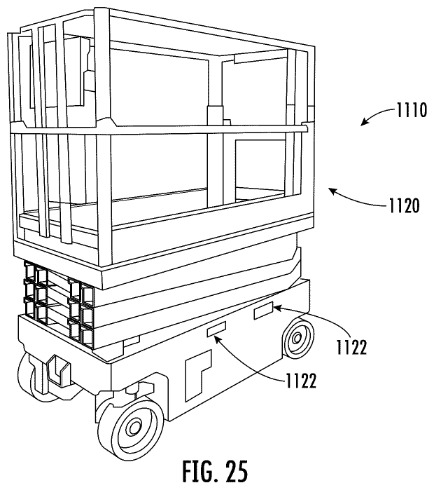

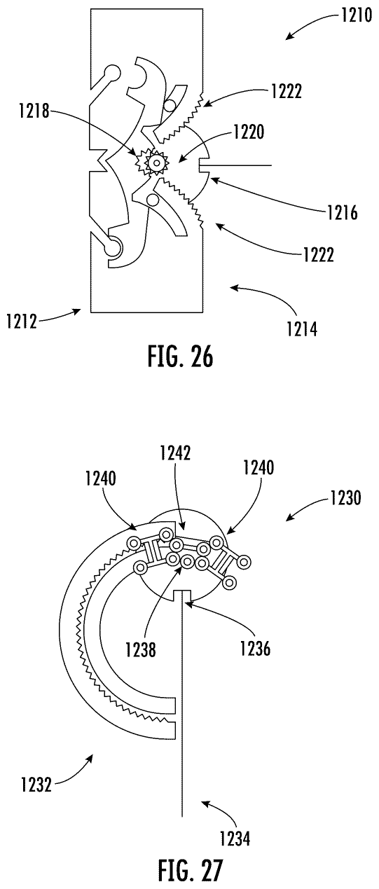

Referring to FIG. 25, as background, laser devices of laser layout system 1110 can be coupled to platform 1120 at mounting locations 1122. However, coupling the laser devices on a wall can limit the field of view of the laser devices, such as by the wall blocking the laser device seeing straight down or nearly straight down and next to the platform. Accordingly, various aspects of the laser layout systems described herein use one or more of the turrets shown in FIGS. 25-39. The turrets shown in FIGS. 26-39 provide the ability to pivot the laser emitter to a location (e.g., outside the wall of the platform) from which the laser emitter emit the laser to more locations, such as straight down and next to the platform. Further, the turrets shown in FIGS. 26-39 provide the ability to actuate between a high visibility location that permits the turret to emit light at the ground and the floor (e.g., extending on a shelf on the side of the lift), and a protected location that protects the turret from being damaged when the is moving past nearby objects, such as walls. In various embodiments, one or more of the turrets shown in FIGS. 26-39 are magnetized (e.g., include at least one magnet) that couples the respective turret to location(s) on the lift, such as the top of the shelf of the lift and/or to the side of the lift.

Referring to FIG. 26, various aspects of turret 1210 are shown. Turret 1210 may be used with any of the laser layout systems described herein to improve the functionality, such as by providing a larger field of view for one or more of the laser emitters.

Turret 1210 includes a motor 1218 that spins a cog 1220 around two cogged faces 1222 as laser 1216 moves from inside 1212 to outside 1214 the platform. There are two pivot points central to the two radii of the cogged faces 1222 around which the turret 1210 will pivot. Depending on whether the laser 1216 needs to point left or right, it will pivot about the respective cogged face 1222.

Referring to FIG. 27, various aspects of turret 1230 are shown. Turret 1230 may be used with any of the laser layout systems described herein to improve the functionality, such as by providing a larger field of view for one or more of the laser emitters. Turret 1230 is substantially the same as turret 1210 except for the differences discussed herein.

Motor 1238 spins a single spur gear 1242 that rides around a half-mooned face as laser 1236 moves between inside 1232 of the platform and outside 1234 of the platform. Rollers 1240 (e.g., bearing surfaces) similar to a roller coaster keep the turret 1230 on the half-moon as motor 1238 moves turret 1230. As the turret 1230 approaches the end of the track, one set of rollers 1240 will come off the track allowing the turret 1230 to extend past the edge of the lip of the platform. This happens on both sides of the half-moon for bi-directionality.

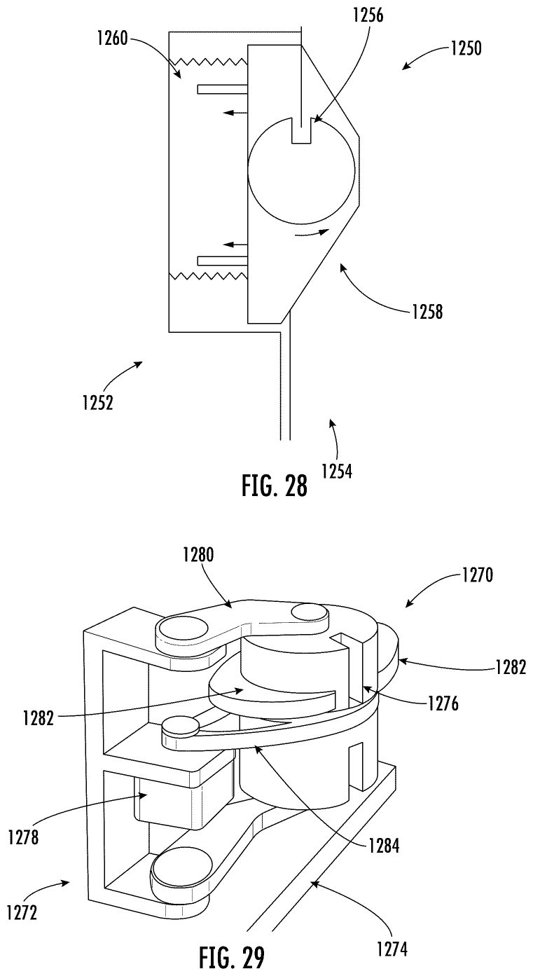

Referring to FIG. 28, various aspects of turret 1250 are shown. Turret 1250 may be used with any of the laser layout systems described herein to improve the functionality, such as by providing a larger field of view for one or more of the laser emitters. Turret 1250 is substantially the same as turret 1210 or turret 1230 except for the differences discussed herein.

In various embodiments, turret 1250 is placed outside 1254 the footprint of the platform, rather than inside 1252 and pivoting outside 1254 the platform. When the turret 1250 is outside 1254 the platform, the laser 1256 can shoot to any location required by the user. If the operator happens to collide into something, the ramps 1258 and spring system 1260 will allow the turret to collapse into the footprint of the platform without significantly damaging the turret 1250.

In various embodiments, ramps 1258 and spring system 1260 could be located within an individual turret 1250. In various other embodiments, ramps 1258 and spring system 1260 are spread across the entire footprint of the platform.

Referring to FIG. 29, various aspects of turret 1270 are shown. Turret 1270 may be used with any of the laser layout systems described herein to improve the functionality, such as by providing a larger field of view for one or more of the laser emitters. Turret 1270 is substantially the same as turret 1210, turret 1230, or turret 1250 except for the differences discussed herein.

In various embodiments, this design keeps turret 1270 positioning flush to the edge of the lip of the platform until it gets to a specific clockwise (CW) or counter-clockwise (CCW) angle. The cam surface 1282 will contact a surface on the inside face of the inside 1272 of the platform and will force the turret 1270, including the laser 1276, and pivoting arm 1280 to swing outward towards the outside 1274 of the platform.

The motor 1278 is pivoted colinearly with the pivot arm 1280 so that the length of the belt 1284 does not grow or shrink. Alternatively, an idler pulley would be installed.

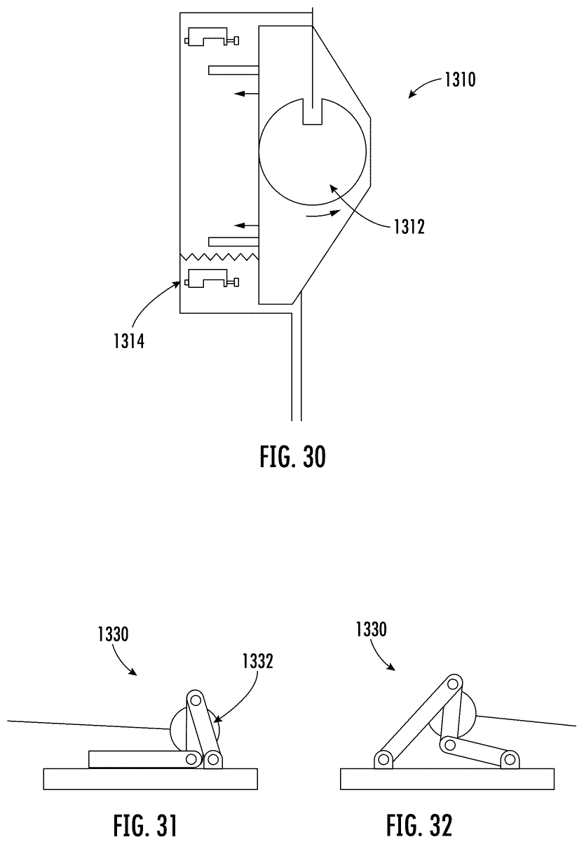

Referring to FIG. 30, various aspects of turret 1310 are shown. Turret 1310 may be used with any of the laser layout systems described herein to improve the functionality, such as by providing a larger field of view for one or more of the laser emitters. Turret 1310 is substantially the same as turret 1210, turret 1230, turret 1250, or turret 1270 except for the differences discussed herein.

In particular, turret 1310 is similar to turret 1250 except for the differences discussed herein. Specifically, turret 1310 includes actuators 1314 and a motor 1312 that actuate the turret 1310 when movement is sensed (e.g., via an accelerometer), thereby reducing the chances of damage to turret 1310. Once the platform stops (e.g., so movement is no longer sensed), turret 1310 can again deploy exterior to the footprint of the platform.

Referring to FIGS. 31-32, various aspects of turret 1330 are shown. Turret 1330 may be used with any of the laser layout systems described herein to improve the functionality, such as by providing a larger field of view for one or more of the laser emitters. Turret 1330 is substantially the same as turret 1210, turret 1230, turret 1250, turret 1270, or turret 1310 except for the differences discussed herein.

Turret 1330 uses a 4-bar mechanism to swing the turret 1330 out in one direction and in the center of the field of view (FOV). In various embodiments, the 4-bar mechanism is actuated via motor 1332. FIGS. 31 and 32 depict two different configurations between which the motor 1332 actuates the 4-bar mechanism.

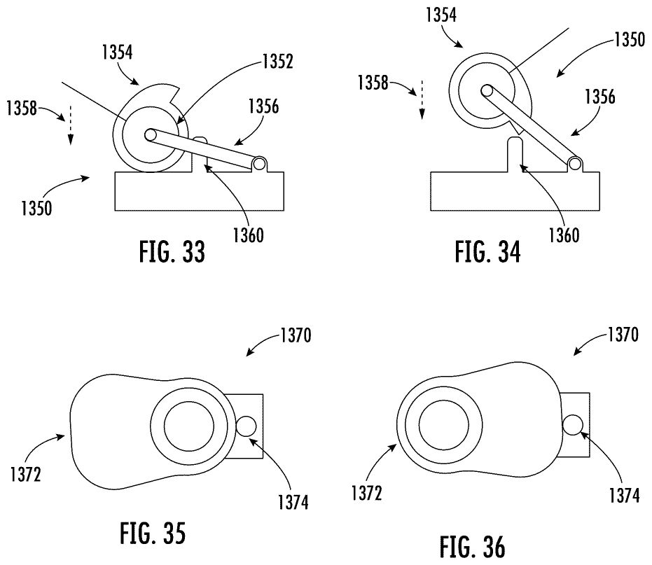

Referring to FIGS. 33-34, various aspects of turret 1350 are shown. Turret 1350 may be used with any of the laser layout systems described herein to improve the functionality, such as by providing a larger field of view for one or more of the laser emitters. Turret 1350 is substantially the same as turret 1210, turret 1230, turret 1250, turret 1270, turret 1310, or turret 1330 except for the differences discussed herein.

Turret 1350 motorizes (e.g., via motor 1352) a cam wheel 1354 and spring loads pivot arm 1356 in direction 1358. This forces the wheel 1354 to pop over the vertical barrier 1360 causing wheel 1354 to pop out from the side of the platform.

Referring to FIGS. 35-36, various aspects of turret 1370 are shown. Turret 1370 may be used with any of the laser layout systems described herein to improve the functionality, such as by providing a larger field of view for one or more of the laser emitters. Turret 1370 is substantially the same as turret 1210, turret 1230, turret 1250, turret 1270, turret 1310, turret 1330, or turret 1350 except for the differences discussed herein.

Turret 1370 uses a motorized cam 1372 and a spring loaded slider underneath the cam 1372 to constrain the turret 1370 into and out of the lip of the platform as the cam 1372 face rides on the pin 1374 shown.

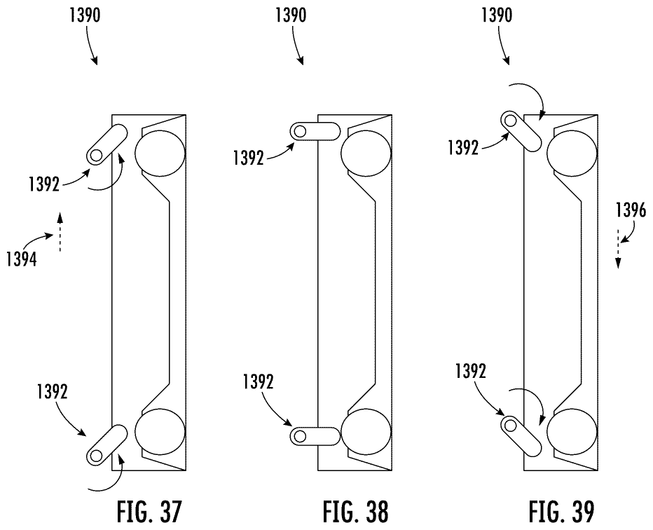

Referring to FIGS. 37-39, various aspects of turret 1390 are shown. Turret 1390 may be used with any of the laser layout systems described herein to improve the functionality, such as by providing a larger field of view for one or more of the laser emitters. Turret 1390 is substantially the same as turret 1210, turret 1230, turret 1250, turret 1270, turret 1310, turret 1330, turret 1350, or turret 1370 except for the differences discussed herein.

In particular, turret 1390 is similar turret 1250, but instead of the unit sliding linearly into and out of the center of the platform, turret 1390 is mounted to two pivoting linkages 1392. In various embodiments, linkages 1392 are spring-biased towards the position shown in FIG. 38. Referring to FIG. 37, if turret 1390 receives contact while the platform is going in direction 1394, the linkages 1392 rotate so that turret 1390 moves in direction 1394. Referring to FIG. 39, if turret 1390 receives contact while the platform is going in direction 1396, the linkages 1392 rotate so that turret 1390 moves in direction 1396. In various alternative embodiments, turret 1390 includes one or more motors that rotate linkages 1392 in response to detecting contact with turret 1390.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A laser layout system comprising:
a mobile work platform comprising a base moveable across a floor, legs coupled to the base, and a lift coupled to the legs, the lift actuating between a retracted position closest to the base and an extended position furthest from the base; and
a laser device coupled to the lift, the laser device configured to emit one or more lasers at installation points on a surface, wherein the laser device emits the one or more lasers based on one or more of Building Information Modeling (BIM) data to determine a height of a ceiling, data from a sensor that indicates a location of the lift, and data from a sensor that indicates an orientation of the lift.

2. The laser layout system of claim 1, wherein the lift actuates vertically with respect to the base between the retracted position and the extended position.

3. The laser layout system of claim 1, wherein the laser device is configured to emit a first laser of the one or more lasers upward from the laser device.

4. The laser layout system of claim 3, wherein the laser device is configured to emit the first laser at a first installation point on the ceiling.

5. The laser layout system of claim 4, wherein the laser device is configured to emit the first laser at the first installation point based at least in part on determining the height of the ceiling at least in part on the BIM data.

6. The laser layout system of claim 4, wherein the laser device is configured to emit the first laser at the first installation point based at least in part on determining the orientation of the lift.

7. The laser layout system of claim 5, wherein the laser device is configured to emit a second laser of the one or more lasers downward from the laser device.

8. The laser layout system of claim 7, wherein the laser device is configured to emit the second laser at a second installation point on a floor.

9. The laser layout system of claim 4, wherein the laser device is configured to emit a second laser of the one or more lasers downward from the laser device.

10. The laser layout system of claim 9, wherein the laser device is configured to emit the second laser at a second installation point on a floor.

11. A laser layout system comprising:
a mobile work platform comprising a base moveable across a floor, legs coupled to the base, and a lift coupled to the legs, the lift actuating between a retracted position closest to the base and an extended position furthest from the base;
an arm pivotally coupled to the lift; and
a laser device coupled to the arm, the laser device configured to emit one or more lasers at installation points on a surface.

12. The laser layout system of claim 11, wherein the laser device is slidably coupled to the arm.

13. The laser layout system of claim 11, wherein the laser device is configured to emit a first laser of the one or more lasers upward from the laser device at a first installation point on a ceiling.

14. The laser layout system of claim 13, wherein the laser device is configured to emit the first laser at the first installation point based at least in part on determining a height of the ceiling.

15. The laser layout system of claim 14, wherein the laser device is configured to emit a second laser of the one or more lasers downward from the laser device at a second installation point on a floor.

16. The laser layout system of claim 13, wherein the laser device is configured to emit a second laser of the one or more lasers downward from the laser device at a second installation point on a floor.

17. A method of using a laser layout system comprising:
receiving an image from a camera of one or more objects;
detecting a selection portion on an electronic device that corresponds to a location in the image, wherein the selection portion is detected via detecting a user interfacing with a touch screen interface that is displaying the image; and
adjusting a laser emitted by a laser device to aim at the location on the one or more objects in response to the detection of the selection portion.

18. The method of claim 17, wherein the electronic device comprises a cellular phone.

19. The method of claim 17, comprising:
displaying, in response to detecting the selected portion, a detailed view of the selected portion.

20. The method of claim 19, wherein the detailed view is displayed on the touch screen interface.
